(19) United States
(12) Patent Application Publication
(10) Pub. No.: US 2019/0130367 A1
(43) Pub. Date: May 2, 2019

(54) INTELLIGENTLY ORGANIZING A DIRECTORY IN A ROOM MANAGEMENT SYSTEM

(71) Applicant: Facebook, Inc., Menlo Park, CA (US)

(72) Inventors: Oliver Pell, London (GB); Robert James Cooper, Bromley (GB)

(21) Appl. No.: 15/796,795

(22) Filed: Oct. 28, 2017

(51) Int. Cl. G06Q 10/10

(52) U.S. Cl. CPC G06Q 10/1095

(57) ABSTRACT

A room management system includes one or more room management clients inside of respective meeting rooms and one or more room management clients outside of the respective meeting rooms that are all coupled to a room management server. The room management system perform various operations to help facilitate the scheduling and conduct of meetings in the meeting rooms. For example, the room management system may facilitate notifications to attendees in a meeting room when the meeting is scheduled to come to an end. The room management system may furthermore facilitate identification and scheduling of an alternative meeting room to continue a meeting that overruns its scheduled time. Furthermore, the room management system may provide a smart directory that intelligently determines and presents a ranked list of people and/or other meeting rooms that attendees in a meeting room are likely to want to call during the meeting.

### BACKGROUND

This disclosure relates generally to a room management system for managing meeting rooms.

Management of meeting rooms in a business environment is important to ensure the rooms are utilized in an efficient manner. Conventionally, meeting rooms can be reserved for specific time periods using a manual scheduling system or a simple calendar application. These primitive systems do not do anything to help facilitate the meeting or enforce the schedule. Therefore, a more advanced room management system is desired.

### SUMMARY

A method, non-transitory computer-readable storage medium, and computing device organizes a directory of entities (e.g., rooms or people) based on a predicted likelihood of an individual wanting to contact the entity. A directory optimization module detects one or more individuals having access to a directory of entities that can be contacted from the room management client. A processor determines likelihood scores for each of the entities in the directory. The likelihood scores are indicative of respective predicted likelihoods that the one or more individuals having access to the directory of entities on the room management client will want to contact each of the respective entities in the directory. A presentation of the entities in the directory is organized based on the likelihood scores to generate a ranked list of entities. The ranked list of entities is displayed on the room management client.

Detecting the one or more individuals having access to the directory may be based on detecting a proximity of the one or more individuals to the room management client.

In an embodiment, the likelihood scores may be determined by identifying expected participants in a meeting scheduled in a room at a location of the room management client, detecting a subset of the expected participants that are absent from the one or more individuals detected in the vicinity of the room management client, and determining the likelihood scores based on detecting the subset of the expected participants that are absent.

In an embodiment, the likelihood scores may be determined by determining a room location associated with the room management client, determining entity locations associated with each of the entities in the directory, determining respective distances from the originating location to each of the target locations, and determining the likelihood scores based on the respective distances. The entity locations may comprise expected locations based on a stored calendar event associated with the entities or an estimated location based on a detection of the entity by a proximity detector located at the estimated location.

In another embodiment, the likelihood scores may be determined by determining local times at estimated locations associated with each of the entities in the directory, determining respective availability metrics indicating whether or not each of the entities are at estimated locations with local times falling within predefined business hours, and determining the likelihood scores based on the respective availability metrics.

In yet another embodiment, the likelihood scores may be determined by determining presence of target individuals within each of the rooms, determining a historical frequency of communications from the one or more individual having access to the directory and each of the target individuals, and determining the likelihood scores for the rooms based on the historical frequency.

In yet another embodiment, the likelihood scores may be determined by determining from a social network database, connectivity metrics between the one or more individuals having access to the directory on the room management client and each of the respective entities in the directory, and determining the likelihood scores for the respective entities based on the connectivity metrics.

In an embodiment, the presentation of the entities may be organized by including entities over a first threshold likelihood score in the ranked list of entities and excluding entities below a second threshold likelihood score from the ranked list of entities.

In an embodiment, the likelihood scores may be determined by learning a machine-learned model from tracked communications between the one or more individuals having access to the directory and the entities in the directory. The machine-learned model indicating correlations between the tracked communications, the one or more individuals, the entities in the directory, and circumstantial factors. The likelihood scores are determined based on the machine-learned model.

### BRIEF DESCRIPTION OF THE DRAWINGS

FIG. 1 is a block diagram of a system environment for a room management system in accordance with an embodiment.

FIG. 2 is a block diagram of a room management client in accordance with an embodiment.

FIG. 3. is a block diagram of a room management server in accordance with an embodiment.

FIG. 4 is a flowchart illustrating an embodiment of a process for generating notifications to a room management client in accordance with an embodiment.

FIG. 5 is a flowchart illustrating an embodiment of a process for managing a relocation of a meeting to an alternative meeting room to avoid a scheduling conflict, in accordance with an embodiment.

FIG. 6 is a flowchart illustrating an embodiment of a process for intelligently ranking individuals or rooms in a directory, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

A room management system includes one or more room management clients inside and/or outside one or more meetings rooms. The room management clients are coupled to a room management server that communicates with and manages functions of the room management clients. The room management system perform various operations to help facilitate the scheduling and conduct of meetings in the meeting rooms. For example, the room management system may facilitate notifications to attendees in a meeting room when the meeting is scheduled to come to an end. The room management system may furthermore facilitate identification and scheduling of an alternative meeting room to continue a meeting that overruns its scheduled time. Furthermore, the room management system may provide a smart directory that intelligently determines and presents a ranked list of people and/or other meeting rooms that attendees in a meeting room are likely to want to call during the meeting.

### System Architecture

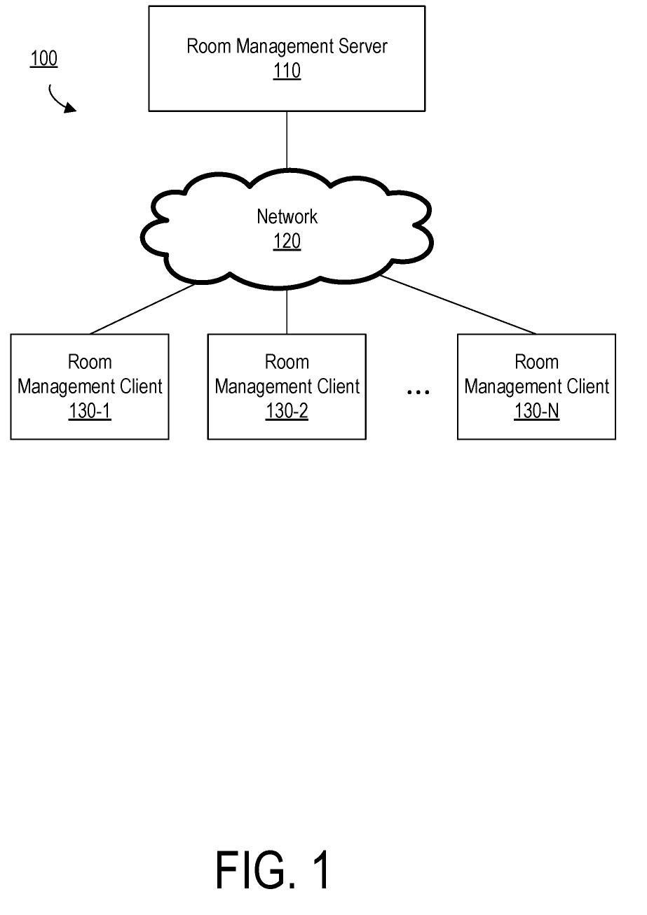

FIG. 1 is a block diagram of a room management system 100. The room management system 100 comprises a room management server 110, a network 120, and a plurality of room management clients 130-1, 130-2, . . . , 130-N (collectively referred to herein as room management clients 130). In alternative configurations, different and/or additional components may be included in the room management system 100.

The room management clients 130 are network-enabled computing devices capable of communicating data over the network 120, receiving user input, and outputting information to users. In one embodiment, the room management clients 130 may comprise specialized computing devices having functionality limited to that sufficient to perform the room management functions described herein. For example, the room management client 130 may be configured to execute a simple operating system and a relatively lightweight room management client application without necessarily being able to execute other more general applications. Furthermore, the room management client 130 may have hardware sufficient to execute the room management client application without necessarily including more complex general purpose hardware. Thus, the room management clients 130 may be constructed at relatively low cost and complexity compared to a general purpose computing device since they are customized to perform a limited number of specialized functions.

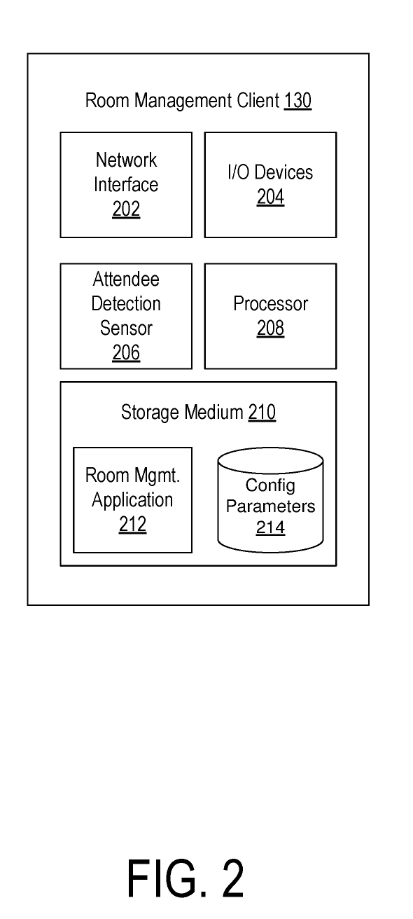

In another embodiment, a room management client 130 may comprise a conventional general purpose computer system. In these embodiments, the room management client 130 may comprise hardware and software associated with general computing systems. Here, the room management client 130 may execute a room management client application that enables it to perform functions of the room management client 130 described herein, but may also perform other more general functions. For example, a room management client 130 may comprises a laptop computer, tablet, smartphone, or smartwatch that executes a room management client application. An example embodiment of a room management client 130 is described in further detail below with respect to FIG. 2.

The room management clients 130 may be placed throughout a business facility or other location. For example, in an embodiment, each meeting room within a business facility may have a room management client 130 located directly outside the meeting room and another room management client 130 inside the meeting room. The room management client 130 outside the meeting room may be used to display information about a meeting schedule associated with the meeting room, detect individuals waiting outside the meeting room, receive various inputs from individuals outside the meeting room, and perform other tasks described herein. The room management client 130 inside the meeting room may be used to display information about a scheduled meeting, detect individual inside the meeting room, receive various inputs from individuals inside the meeting room, control external devices inside the meeting room, facilitate telephone or video calls between the meeting room and an external location, and perform other tasks described herein.

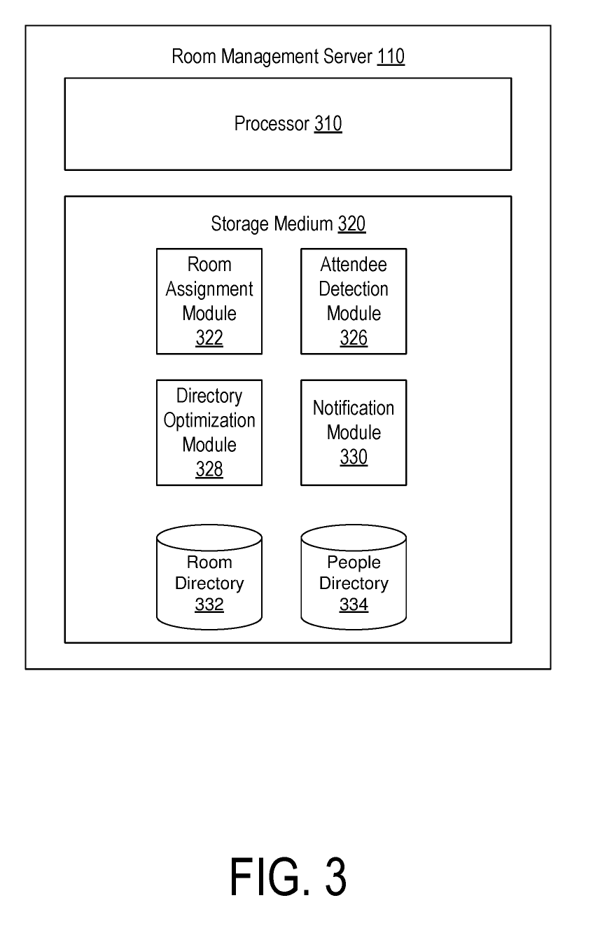

The room management server 110 comprises a computing device that performs various functions to facilitate use of meeting rooms in conjunction with the room management clients 130. For example, the room management server 110 may maintain a calendar that tracks meeting room reservations and sends information to the appropriate room management client 130 (e.g., to display the schedule associated with the meeting room). The room management server 110 may also receive information from the room management clients 130 indicative of various user inputs received, process the user inputs, and send results to the room management clients 130 or other networked devices. For example, the room management server 110 may receive user inputs to change a reservation associated with the meeting room, to control a device in the meeting room, to send a notification to one or more room management clients 130, to call or video conference another meeting room, to present requested information, or to process other requests. The room management server 110 may furthermore retain a directory of people and/or other meeting rooms that can be called during a meeting form a local room management client 130 and facilitate such calling between the entities. Further still, the room management server 110 may control configuring of the room managements clients 130, updating of the room management clients 130 with new versions of the room management application, and may perform various troubleshooting tasks to identify and resolve any malfunctions of the room management clients 130. An embodiment of a room management server 110 is described in further detail below with respect to FIG. 3.

The network 120 facilitates communications between the room management clients 130, the room management server 110, and any other devices on the network 120. The network 120 may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable encryption technique.

### Room Management Client

FIG. 2 is a block diagram of an embodiment of a room management client 130. The room management client 130 includes a network interface 202, input/output (I/O) devices 204, attendee detection sensors 206, a processor 208, and a storage medium 210. The storage medium 210 stores a room management application 212 and configuration parameters 214. In other embodiments, the room management client 130 may include additional, fewer, or different components.

The network interface 202 comprises hardware, firmware, and/or software to facilitate communication with the network 120. The network interface 202 may utilize any conventional wired or wireless communication protocols or a custom communication protocol.

The I/O devices 204 include hardware, firmware, and/or associated software to enable users to provide inputs to the room management client 130 and to enable the room management client 130 to provide various outputs. For example, the I/O devices 204 may include input devices such as a touch sensor or touch panel, a keyboard or keypad, a mouse, a joystick, a gesture recognition system, a microphone, a voice recognition system, physical buttons, dials, or switches, or other input devices. Furthermore, the I/O devices 204 may include integrated output devices such as a display screen, a speaker, a haptic feedback device, or other output device. The I/O devices may also include communication ports to enable the room management client 130 to control external devices such as external displays, speakers, or communication devices.

The attendee detection sensor 206 detects identifying information associated with people that are in proximity to the room management client 130. For example, the attendee detection sensor 206 may comprise a badge reader such as a magnetic strip reader or a radio-frequency identifier (RFID) sensor that detects an RFID fob or card held by an individual in proximity to or that interacts with the room management client 130. Alternatively, the attendee detection sensor 206 may comprise a wireless communication device (e.g., a Bluetooth, WiFi Direct, or Near Field Communication (NFC) device) that is configured to detect a wireless signal from a device (e.g., a mobile phone or tablet) carried by a person in proximity to the room management client device 130 and identify the individual associated with the device. In yet another embodiment, the attendee detection sensor 206 may comprise a face recognition device, fingerprint sensor, retina sensor, or other biometric sensor that can be uniquely detect an individual in proximity to or interacting with the room management client 130. In each of these embodiments, the attendee detection sensor 206 obtains a unique identifier of a person in proximity to the room management client 130. This identifier can be sent to the room management server 110 in order to identify the individual and thereby track who is entering or leaving meeting rooms, or otherwise in proximity to the room management client 130.

In other embodiments, the attendee detection sensor 206 may be omitted and one or more individuals may instead manually log into the room management client (e.g., using a username and password or other credentials) via a user interface. In this embodiment, the room management client 130 may similarly send identifying information associated with the individual logging in to the room management server 110 so that the room management 110 can track the individuals that are currently at a location associated with a particular room management client 130.

In yet other embodiments, the attendee detection sensor 206 can detect the presence of an individual without necessarily detecting the individual's identity. In this case, the attendee detection sensor 206 may indicate that an anonymous individual is detected.

The room management application 212 comprises instructions stored to the storage medium 210 (e.g., a non-transitory computer-readable storage medium) that when executed by the processor 208, carry out functions attributed to the room management client 130 described herein. For example, the room management application 212 may include a graphical user interface that enables individuals to access various features, which may be processed locally by the room management application 212, remotely by the room management server 110, or as a combination thereof. The user interface may present various controls and menus to enable a user to interact with the room management system 100. Furthermore, the user interface may provide various information to users. For example, the user interface may enable users to perform tasks such as accessing and searching a directory of people and other meeting rooms, controlling various devices in the meeting such as displays and speakers, calling or video conferencing with other people or meeting rooms, display a meeting room schedule associated with the meeting room, and displaying various alerts or notifications on a display screen.

The configuration parameters 214 comprise one or more parameters stored to the storage medium 210 that can be configured differently for different room management clients 130 in order to affect their individual operating characteristics. Different room management clients 130 may be configured with different configuration parameters 214 depending on their location and intended use. For example, room management clients 130 located inside a meeting room may be configured to operate as “inside-type” room management clients 130 while room management clients located outside of a meeting room may be configured to operate as “outside-type” room management clients. The configuration parameters 214 may furthermore include factors such as a geographical location or building where the room management client 130 is located, a business unit associated with the location of the room management client, an access-level associated with the location of the room management client (e.g., if the meeting room is a secure meeting room, a non-secure meeting room, or a publically available meeting room), or other factors that may relate to the desired operation of the room management client 130.

The different room configuration parameters 214 may cause different versions of the room management application 212 to be installed or executed on the room management client 130 and/or may enable or disable different features of the room management application 212. For example, a room management client 130 provisioned for use inside a meeting room may be able to control devices within the room (e.g., display screens, lighting, etc.) while this function may be disabled in a room management client 130 provided for use outside the meeting room. Furthermore, a room management client 130 provisioned for use inside a meeting room may be configured to provide notifications and options for continuing a meeting elsewhere when a scheduled meeting time is coming to an end, while such functionality may not be included in a room management client 130 provisioned for use outside the meeting room.

### Room Management Server

FIG. 3 illustrates an example embodiment of a room management server 110. The room management server 110 comprises a processor 310 and a storage medium 320 (e.g., a non-transitory computer-readable storage medium). The storage medium 320 stores various modules comprising instructions that when executed by the processor 310 causes the processor 310 to perform functions associated with the room management server 110 described herein. In an embodiment, the storage medium 320 stores a room assignment module 322, an attendee detection module 326, a directory optimization module 328, a notification module 330, a room directory 332, and a people directory 334. In alternative embodiments, the room management server 110 may include additional, fewer, or different modules or the functionality associated with each module may be distributed differently.

The room directory 332 and people directory 334 comprise lists of meeting rooms and people respectively associated with an organization in which the room management system 100 operates. Each directory 332, 334 may comprise, for example, a database or table storing various information associated with the respective entities. For example, the room directory 332 may store a unique identifier for each room, a room name, a room number, a room location, a room capacity, room capabilities (e.g., audio conferencing, video conferencing, etc.), a calendar associated with the meeting room, or other information associated with a meeting room. The people directory 334 may similarly store a unique identifier associated with each person in the organization, a name, title, business unit, project assignment, phone number, email address, current location, calendar associated with the individual's schedule, or other information associated with individuals in an organization. The directories 332, 334 may furthermore store historical or real-time information associated with the rooms and people. For example, the room directory 332 may store a current indication of which people are in a room or waiting outside the room and a historical indication of people that entered and left a room together with relevant timestamps. Similarly, the people directory 334 may store a current indication of a room where a particular person is located or historical information about which rooms that person entered or left together with relevant timestamps.

The attendee detection module 326 communicates with attendee detection sensors 206 on the room management clients 130 to determine which individuals are in proximity to a particular room management client 130. This information may be used to determine, for example, which individuals are in a given meeting room at a given time and which individuals are waiting outside a given meeting room at a given time, and to track when individuals enter and leave a given room. For example, the attendee detection module 326 may receive an identifier from an attendee detection sensor 206 indicating detection of an individual and an identifier associated with the room management client 130. The attendee detection module 326 may then update the directories 322, 324 to store an association between the identifier of the detected individual and the identifier for the room associated with the room management client 130. Because the room directory 332 indicates whether the room is an inside-type or an outside-type room management client 130, the attendee detection module 326 may furthermore determine whether the detected individual is inside the meeting room or waiting outside the meeting room. In other embodiments, the attendee detection module 326 may simply detect a manual log in event to a room management client 130 from one or more individuals based on credentials or other identifying information entered on the room management client 130. In other embodiments, the attendee detection module 326 may predict an individual's presence without necessarily receiving any detection signal from the detection sensor 206. For example, the attendee detection module 326 may predict presence based on a calendar entry that indicates that the individual is scheduled to be in a particular place at a particular time. In other embodiments, the attendee detection module 326 may detect or predict the presence of an anonymous individual without necessarily determining the individual's identity.

The notification module 330 facilitates communications from the room management server 130 to the room management clients 130 and may also facilitate communications between different room management clients 130. For example, the notification module 330 may send notifications to appropriate room management clients 130 inside a meeting room or outside of a meeting room when a scheduled meeting is scheduled to begin or end. The notification module 330 may furthermore facilitate communications between an outside-type room management client 130 outside a given meeting room and an inside-type room management client 130 inside the given meeting room. For example, when an existing meeting is scheduled to end and another meeting is scheduled to begin, an individual outside of the meeting room may select a control on the outside-type room management client 130 to send a custom or default message to the inside-type room management client 130 (e.g., “We are waiting for the meeting room.”). This message is sent to the notification module 330 of the room management server 110 and relayed to the inside-type room management client 130 for the room. Alternatively, this message may be automatically sent from the notification module 130 at a scheduled time when an existing meeting is ending and the new meeting is scheduled to begin.

In another embodiment, the attendee detection module 326 may determine when a quorum of individuals (e.g., over a predefined threshold number or percentage) of individuals scheduled to attend a scheduled meeting are waiting outside an occupied meeting room and cause the notification module 326 to automatically send a notification to the inside-type room management client 130 when the quorum is achieved.

In another example, the notification module 330 may facilitate a communication from an inside-type room management client 130 to an outside-type room management client 130. For example, an individual in the meeting room may want to send a message indicating that they are wrapping up the meeting and will be exiting in a few minutes.

In yet another embodiment, the notification module 330 may facilitate communication from another networked device and a room management client 130. For example, if an individual is receiving a call or a message on a device in the individual's office and the individual is detected as being present in a meeting room, the notification module 330 may automatically re-route the call or message to the room management client 130 near the individual.

The room assignment module 322 stores a calendar indicating a schedule of meetings associated with different rooms. For example, each entry in the calendar may store a room identifier for the room associated with a meeting, a start time and end time for the meeting, and one or more persons expected to attend or actually attending the meeting. The room assignment module 322 may be used, for example, to receive and store advance reservations for a meeting. Furthermore, the room assignment module 322 may be able to automatically detect and calendar an unscheduled meeting by detecting individuals entering a room during an otherwise unscheduled time slot. In one embodiment, the room assignment module 322 may send room assignment information to outside-type room management clients 130 outside of meeting rooms to display information identifying a currently scheduled or future scheduled meeting for that room.

In an embodiment, the room assignment module 322 may furthermore send a notification to an inside-type room management client 130 when an ongoing meeting is scheduled to end. The room assignment module 322 may also send a prompt to the room management client 130 presenting attendees with an option to continue the meeting in case the attendees are not ready for the meeting to end at the scheduled time. If a selection is received via the room management client 130 to continue the meeting and if no new meeting is scheduled to start, the end time may simply be changed to a later end time to extend the meeting by a user-selected or default time period. Otherwise, if another meeting is scheduled to start in the room, the room assignment module 322 may intelligently select another meeting room where the meeting can be relocated to continue the meeting or may relocate the new meeting about to start to a different meeting room.

Various factors may be used to intelligently determine how to relocate one of the meetings. In an embodiment, if the existing room is the only available room that can accommodate one of the two meetings (e.g., due to room size or specialized equipment) and the other meeting can be accommodated by another available room, then the meeting that can be accommodated by a different room may be automatically chosen for relocation. Otherwise, if either meeting could potentially be relocated, determining whether to relocate the existing meeting or the upcoming meeting may be based on a combination of weighted metrics. For example, a first metric may be based on the number of people attending or scheduled to attend each of the meetings with preference for the existing room given to the meeting with more attendees. Another metric may be based on a superiority level of the job titles of the meeting attendees with preference for the existing meeting room generally given to the meeting with higher ranked attendees. Another metric may penalize the current meeting that is overrunning to give preference to the meeting scheduled in advance. A weighted combination of these and/or other metrics may be combined to determine an overall metric score for each meeting, the higher of which may be assigned to the existing room, and the lower of which being re-assigned to a different meeting room.

A variety of factors may also be used to determine a new room for assigning to the scheduled meeting or the continuing meeting. For example, other available rooms (that are not reserved) may be ranked based on factors such as room capacity, specialized equipment available, and distance from the current room. Particularly, in one embodiment, the room assignment module 322 may first determine a subset of rooms that have the appropriate capacity and specialized equipment to accommodate the relocating meeting. From the subset of accommodating rooms, the room assignment module 322 may select the room is closest to the existing meeting room location.

In one embodiment, an existing meeting may be allowed to continue in a room past its scheduled end time until a sufficient number of attendees (e.g., over a threshold number or percentage of the attendee list) are determined to be present for the next scheduled meeting. The threshold number may dynamically change with the time past the scheduled end time. For example, the threshold number may be progressively lowered the further the time is past the scheduled end time. Additionally, the threshold may vary depending on the superiority level of the attendees of the current and new meeting. For example, the threshold may be lowered for a meeting with high level executives compared to a meeting with junior employees.

The directory optimization module 328 intelligently scores entities (e.g., rooms and people) in order to filter, rank, or group the entities a directory displayed on a given room management client 130 to conveniently present the rooms and people in a manner that enables quicker access to those entities that are more likely to be called (e.g., a telephone or video call) or messaged from a given room management client 130 at a given time. For example, the directory optimization module 328 may generate a ranked list of entities sorted according to determined likelihood scores. The ranked list may include all entities in the directories 322, 324 or may include only a filtered subset of entities in which the entities unlikely to be contacted are excluded from the ranked list. The ranked list is provided to the room management client 130 for display in the directory. Thus, at different times, the directories presented at different room management clients 130 may display different ranked lists of entities so as to enable individuals to more conveniently access and contact the most likely individuals or rooms.

The directory optimization module 328 may generate the ranked list of the directory entries for a given room management client 130 at a given time based on a variety of factors. For example, the ranked list may be based on an individual currently logged into or otherwise detected in proximity to the room management client 130. The ranked list may also be based on multiple individuals logged into or in proximity with the room management client 130 at a given time. The ranked list may also change based on the schedule associated with the meeting room and other meeting rooms, the history of calls or messages made from the meeting room, the history of calls or messages made from one or more individuals logged into the room management client 130 or detected in the room, the business units or projects associated with the individual logged into the room management client 130 or detected in the room, the locations of the rooms or individuals in the directories 332, 334, the local times associated with the locations or the rooms or individuals in the directories 332, 334, a connectivity metric from a social network, or a combination of these or other factors.

In an embodiment, the likelihood scores may comprise coarse scores that place the entities in a small number of possible categories (e.g., two, three, or four categories). In an embodiment, a likelihood score can include a binary value in which entities having a first likelihood score correspond to high likelihood targets and entities with a second likelihood score correspond to low likelihood targets. In one embodiment, the low likelihood targets having the lower likelihood scores may be excluded from the ranked list (but may be accessed through a menu option that gives access to the complete directories). Thus, in this embodiment, the scores effectively operates as filter to filter out low likelihood targets from the ranked list.

Alternatively, three different likelihood scores may be used to divide the directory entries into a first group determined to have a high likelihood of being contacted, a second group determined to have a moderate likelihood, and a third group determined to have a low likelihood. In this embodiment, entities in the first group may be presented in a prominent way (e.g., a the top of the directory display) and may be marked to indicate high likelihood, the second group may be presented separately from the first group in a less prominent position (e.g., below the first group or in a separate menu), and the third group may be excluded from the ranked list (but may be separately accessed through a menu option giving access to the complete directories). Thus, in the embodiment, the scoring effectively operates as a combination of filtering out low likelihood targets and then separately categorizing high likelihood targets and moderate likelihood targets.

In other embodiments, the likelihood scores may comprise a larger range of possible scores. For example, in some embodiments, a fine likelihood score calculated based on various metrics may instead be used to rank the entities on an entity-by-entity basis instead of only placing the entities into general categories.

In one embodiment, a combination of coarse and fine likelihood scores may be computed. For example, in a first cut, a coarse likelihood score may indicate whether or not the entity will be included or omitted from the ranked list. Then, fine likelihood scores may be obtained for the entities determined for inclusion in the ranked list (e.g., high likelihood targets) in order to individually rank the entities. Thus, this embodiment effectively filters out low-likelihood targets and then determines a ranking for the high-likelihood targets. In another embodiment, all of the entities may be individually ranked using a fine likelihood score and only entities having over a threshold score are included in the ranked list with the others omitted.

In one example, likelihood scores may be determined in part by identifying entities that are named in a conference call or video call calendar entry associated with the room or an individual that is present in the room at a time corresponding to the calendar entry. Such entities may be scored as high likelihood since it is known that a call with the entity is scheduled at that time from the individual or from the room. Furthermore, entities may be scored in part by identifying attendees scheduled to be in attendance for a scheduled meeting that are not yet present by including these individuals in the ranked list as high likelihood targets. In this case, it is likely that the missing individual will be called from the meeting either to remind the individual of the meeting or to call in the individual from a remote location. For example, the directory optimization module 328 may identify expected participants in a scheduled meeting stored to a calendar application, detecting a presence or absence of the expected participants at the location associated with the calendar entry, and determine likelihood scores based on the presence or absence of each scheduled participant.

In another example, likelihood scores may be determined based on respective projects assigned to individuals in the people directory 334 and their overlap with projects assigned to one or more individuals in the room. For example, individuals assigned to the same project as an individual in a room may be scored as a high likelihood targets.

In another example, likelihood scores may be determined in part based on a historical frequency of calls or messages of that entity with one or more individuals in the room or with the room itself. In this example, entities that are frequently called (e.g., over a threshold number of calls or messages within a given time period) may be categorized as high likelihood targets. Historical call frequency may also be used to compute fine likelihood scores in which a component of the likelihood score is directly proportional to the frequency.

In another example, likelihood scores may be determined in part based on a connectivity metric determined from a combination of known historical connections between an individual in the room and individuals in the directory. This connectivity metric may be determined at least in part from a social network graph and tracked interactions between individuals on the social network. In an embodiment, the connectivity metric may be obtained directly from the social network and may be the same metric or a variation thereof used by the social network to provide ranked lists of connections to individuals on the social network. In an embodiment, the connectivity score may be compared to various thresholds to determine a coarse likelihood score (e.g., high likelihood target, low likelihood target, or moderate likelihood target) for an entity. Furthermore, in an embodiment, the connectivity metric may be used to rank entities. Here, a component of a fine likelihood score may be directly proportional to the connectivity metric.

In another example, likelihood scores for rooms in the room directory 332 be determined based on whether or not a meeting is in progress in that room. For example, rooms without any scheduled meeting may be scored as low likelihood targets and may be excluded from the ranked list because it is expected that no one is present in those rooms. Rooms with ongoing meetings may be scored as high likelihood targets.

In another example, likelihood scores may be determined based on the respective locations of the entities. Here, the location may comprise an expected location of an individual based on a calendar entry that indicates a location where the individual is scheduled to be present. Alternatively, the location may comprise an estimated location based on a proximity detection of the individual by a proximity detector at the estimated location. For example, entities that are within a threshold proximity of the room management client 130 may be categorized as low likelihood targets and may be excluded from the ranked list because it is unlikely that individuals will want to have a call with an entity already in the room or in close proximity. Alternatively, a fine likelihood score may be computed in which a component of the likelihood score may be directly proportional to the distance.

In another example, likelihood scores may be determined based on the respective local times at the respective location of the entities. Here, an entity at a location where the local time is outside of predefined normal business hours may be scored as low likelihood targets or may be excluded from the ranked list because the entity is unlikely to be available at the moment.

In some embodiments, a number of different factors may each provide components of a coarse or fine likelihood score that may be weighted and combined to generate combined likelihood scores used to filter, categorize, or rank the entities.

In an embodiment, a machine-learning algorithm may be applied to learn which entities are high likelihood or low likelihood targets under different circumstances. For example, by tracking all calls and messages made between entities together with other circumstantial factors (e.g., time, location, etc.) associated with the calls and messages, the directory optimization module 328 may learn correlations between the occurrences of the calls, the entities involved, and the circumstantial factors. A machine-learned model may be generated from the learned correlations. The directory optimization module 328 may then filter or rank entities based on the machine-learned model.

### Process for Generating Notifications

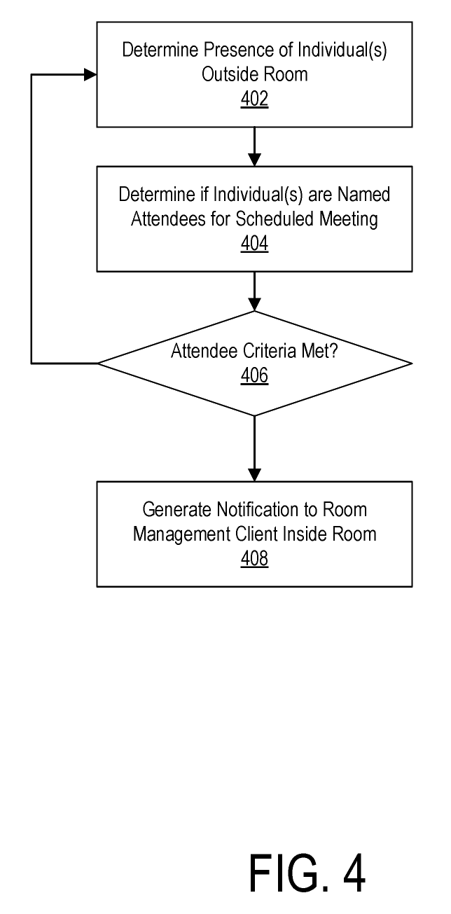

FIG. 4 illustrates an embodiment of a process for generating a notification to a room management client 130 inside a room when attendees for a scheduled meeting are waiting for the room. The notification module 330 determines 402 the presence of one or more individuals outside of a room by receiving a detection signal from an outside-type room management client 130. The room management client 130 may generate the detection signal in response to the one or more individuals manually logging into the room management client 130 or in response to detecting the one or more individuals in proximity to the room management client 130. Alternatively, the detection signal may be generated in response to the individual selecting a control on the room management client 130 and the individual's identity may be detected in response to the detection. The notification module 330 may determine specific identities of the one or more individuals or may simply detect that one or more individuals are present without necessarily determining their identities.

The notification module 330 determines 404 if the one or more detected individuals are named attendees for a scheduled meeting scheduled to occur within a predefined time period of the current time. For example, in one embodiment, the predefined time period may correspond to the time period between the scheduled meeting start time and end time. Alternatively, the predefined time period may include a buffer period before the scheduled start time (e.g., 5 minutes). Alternatively, if the identities of the attendees are not determined, this step may be omitted.

The notification module 330 determines 406 if an attendee criteria is met. For example, in one embodiment, the notification module 330 tracks an attendee count of individuals that are present outside the room. If identities of the present individuals are determined, then the attendee count may include only the individuals matching the attendee list for the scheduled meeting. Otherwise, if the identities are not determined, the attendee count may correspond to the number of individuals determined to be present. In an embodiment, the attendee criteria is met when over a predefined number of attendees on the attendee list are present. Alternatively, the notification module 330 may compute a ratio of the number of attendees on the attendee list that are present to the total number of attendees on the attendee list, and determine that the attendee criteria is met when the ratio exceeds a threshold ratio. The thresholds may be constant (e.g., manually configured) or may dynamically change based on the current time. For example, the threshold may decrease with increasing time past the scheduled start of the meeting or other reference time (e.g., 5 minutes before the scheduled start time). In other alternative embodiments, the attendee criteria may be met when an attendee having a certain title is present (e.g., a high level execute or manager) regardless of the number of attendees present. In yet other embodiments, a combination of factors may be used.

If the attendee criteria is not met in step 406, the notification module 330 returns to step 402 and the process continues. If the attendee criteria is met in step 406, a notification is generated to the room management client 130 inside the room. The notification may indicate that the meeting is scheduled to end and that the new meeting is ready to begin.

A prompt may be sent to the room management client 130 inside the room together with the notification presenting an option to continue the meeting. Individuals in the room may make a selection using the room management client 130 inside the room whether to continue the meeting or whether they are ready for the meeting to end. If a selection is received to continue the meeting, an indication of the selection is sent to the room assignment module 332 and the room assignment module 332 may intelligently identify a meeting room for either the overrunning meeting or the next scheduled meeting to relocate as described below.

In alternative embodiments, one or more steps of FIG. 4 may be performed on a room management client 130 instead of on the room management server 110. For example, a room management client 130 may generate notifications based on locally-stored calendar information. Furthermore, a room management client 130 may send notifications directly to other room management clients 130.

### Process for Continuing a Meeting

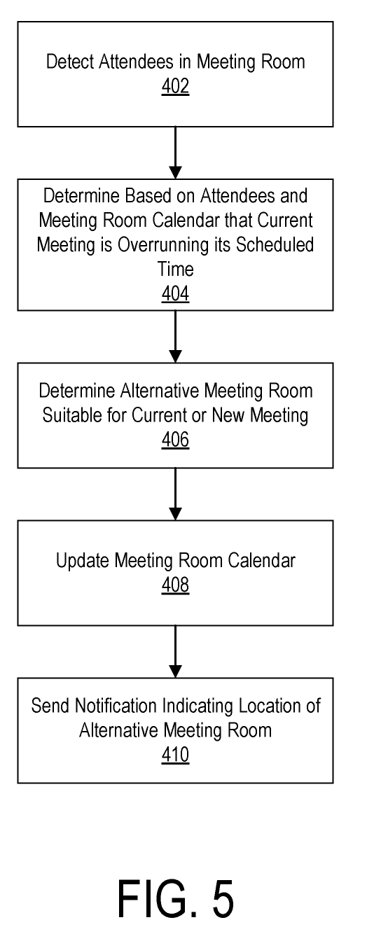

FIG. 5 illustrates an embodiment of a process for facilitating relocation of a meeting from a current meeting room to an alternative meeting room. This may be useful, for example, when an existing meeting is overrunning is scheduled time and a new meeting is scheduled to begin in the same room. The room assignment module 322 may automatically identify and recommend a new meeting room for relocating the current meeting or the new meeting in a manner in an intelligent manner that may optimize the convenience to the meeting attendees.

Particularly, the attendee detection module 326 may detect 502 a presence of one or more meeting attendees in a current meeting room. The room assignment module 332 furthermore determine 504, based on the presence of the attendees and a stored meeting room calendar, that the current meeting in the current meeting room is overrunning a scheduled meeting time and a new meeting is scheduled to begin. An alternative meeting room is then determined 506 that is suitable to accommodate either the current meeting or the new meeting. The meeting room calendar is then updated 508 to specify moving the current meeting or the new meeting to the alternative meeting room. A notification may be sent 510 to a room management client 130 (e.g., inside and/or outside the room) to indicate a location of the alternative meeting room. The notification may furthermore provide directions from the current meeting room to the alternative meeting room.

In an embodiment, the room assignment module 332 may furthermore take actions to facilitate a seamless transition of the meeting from one room to another. For example, the room assignment module 332 may obtain and store a state of a presentation on a display device in the current meeting, and automatically load the state on a display device in the alternative meeting room where the meeting is relocating. Similarly, open telephone or video calls with the room may be transferred to the alternative meeting room.

In one embodiment, the room assignment module 332 may intelligently determine whether to move the current meeting that is overrunning its time or the new meeting that is about to begin. For example, in one embodiment, the room assignment module 332 determines a first candidate meeting room for relocating the current meeting and a second candidate meeting room for relocating the new meeting. The candidate meeting rooms may be determined based on availability, capacity, distance from the current meeting room, or a combination of these or other factors. For example, in one embodiment, the room assignment module 332 queries the meeting room directory 332 to determine if each of the plurality of available meeting rooms have a capacity at least as large as a number of attendees of the new meeting. Locations of these suitable meeting rooms are determined and distances are computed. The respective candidate meeting rooms for moving the current meeting or the new meeting may be selected as the rooms having the shortest distance from among those having appropriate capacity and capabilities.

The room assignment module 332 may select between the candidates for moving the current meeting or the new meeting in order to satisfy some optimization criteria. For example, the optimization criteria may be based on the distances between the current room and the candidate rooms and the number of attendees for the current and new meeting. Particularly, the room assignment module 332 may compute distance metrics based on respective distances from the current room to each of the candidate meeting rooms (e.g., a first distance metric associated with moving the current meeting to the first candidate meeting room a second distance metric associated with moving the new meeting to the second candidate meeting room) and attendee metrics based on the number of attendees in the current and new meeting (e.g., a first attendee metric associated with the current meeting and a second attendee metric associated with the new meeting). Combined metrics are then computed. For example, a combined metric for the current meeting may include a weighted combination of the distance metric and the attendee metric for the current meeting, and a combined metric for the new meeting may include a weighted combination of the distance metric and the attendee metric for the new meeting. In an embodiment, the combined metric for the current meeting may furthermore include a penalty so as to give some preference to the new meeting that was scheduled over the current meeting that is overrunning.

In alternative embodiments, one or more steps of FIG. 5 may be performed on a room management client 130 instead of on the room management server 110. For example, the room management client 130 may obtain the relevant information from the directories 332, 334 and intelligently determine an alternative room for relocating the current meeting or the new meeting according to the same process described above.

### Process for Organizing a Directory

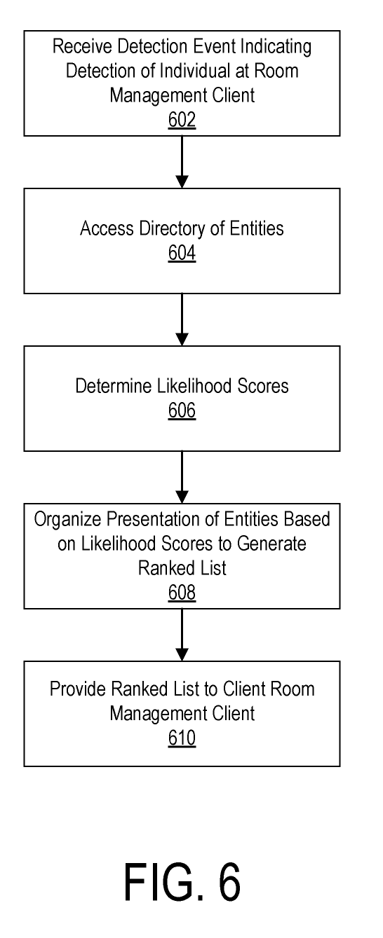

FIG. 6 illustrates an embodiment of a process for dynamically organizing a directory of entities (e.g., rooms and people) based on a predicted likelihood of an individual wanting to call or message each of the entities. The attendee detection module 326 receives 602 a detection event indicating detection of one or more individuals within the vicinity of a room management client 130. The detection may be based on proximity detection or a log in event. Alternatively, the detection may be a prediction that the individual is present based on a calendar entry that schedules the individual to be present. The received detection event may include, for example, an identifier for the room management client 130 and the one or more individuals. The directory optimization module 328 accesses 604 a directory (e.g., directories 332, 334) of entities. The directory optimization module 328 then determines 606 for each of the entities, a respective likelihood score indicative of a likelihood that the one or more detected individuals will want to contact the entity. As described above, the likelihood scores can be calculated based on various factors and may comprise coarse and/or fine likelihood scores. The directory optimization module 328 organizes 608 a presentation of entities based on the likelihood scores to generate a ranked list. The ranked list may optionally exclude entities that are deemed low likelihood targets based on the likelihood scores. The ranked list is then provided to the room management client 130.

In alternative embodiments, one or more steps of FIG. 6 may be performed on a room management client 130 instead of on the room management server 110. For example, in one embodiment, the room management client 130 may download the directories 332, 334 from the room management server 110, determine the likelihood scores locally, and generate the directory presentation.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
detecting one or more individuals having access to a directory of entities that can be contacted from a room management client;
determining by a processor, likelihood scores for each of the entities in the directory, the likelihood scores indicative of respective predicted likelihoods that the one or more individuals having access to the directory of entities on the room management client will want to contact each of the respective entities in the directory;
organizing a presentation of the entities in the directory based on the likelihood scores to generate a ranked list of entities; and
causing the ranked list of entities to be displayed on the room management client.

2. The method of claim 1, wherein detecting the one or more individuals comprises:
detecting a proximity of the one or more individuals to the room management client.

3. The method of claim 1, wherein determining the likelihood scores comprises:
identifying expected participants in a scheduled meeting stored to a calendar application corresponding to a location of the room management client;
detecting a presence or absence of the expected participants at the location; and
determining the likelihood scores based on the presence or absence of the expected participants.

4. The method of claim 1, wherein determining the likelihood scores comprises:
determining a room location associated with the room management client;
determining entity locations associated with each of the entities in the directory;
determining respective distances from the room location to each of the entity locations; and
determining the likelihood scores based on the respective distances.

5. The method of claim 4, wherein determining the entity locations comprises:
determining, based on a stored calendar event associated with a given entity, an expected location of the given entity indicated by the stored calendar event; and
determining the entity locations based on the expected location.

6. The method of claim 4, wherein determining the entity locations comprises:
determining an estimated location of a given entity based on a detection of the given entity by a proximity detector located at the estimated location; and
determining the entity locations based on the estimated location.

7. The method of claim 1, wherein determining the likelihood scores comprises:
determining local times at estimated locations associated with each of the entities in the directory;
determining respective availability metrics indicating whether or not each of the entities are at estimated locations with local times falling within predefined business hours; and
determining the likelihood scores based on the respective availability metrics.

8. The method of claim 1, wherein the entities comprise rooms, and wherein determining the likelihood scores comprises:
determining presence of target individuals within each of the rooms;
determining a historical frequency of communications from the one or more individuals having access to the directory and each of the target individuals; and
determining the likelihood scores for the rooms based on the historical frequency.

9. The method of claim 1, wherein determining the likelihood scores comprises:
determining from a social network database, connectivity metrics between the one or more individuals having access to the directory and each of the respective entities in the directory; and
determining the likelihood scores for the respective entities based on the connectivity metrics.

10. The method of claim 1, wherein organizing the presentation of the entities comprises:
including entities over a first threshold likelihood score in the ranked list of entities; and
excluding entities below a second threshold likelihood score from the ranked list of entities.

11. The method of claim 1, where determining the likelihood scores comprises:
learning a machine-learned model from tracked communications between the one or more individuals having access to the directory and the entities in the directory, the machine-learned model indicating correlations between the tracked communications, the one or more individuals, the entities in the directory, and circumstantial factors; and
determining the likelihood scores based on the machine-learned model.

12. The method of claim 1, wherein determining the likelihood scores for each of the entities in the directory, comprises:
obtaining a calendar entry for a scheduled meeting associated with a first room at a location of the room management client;
detecting that the calendar entry references a second room associated with the scheduled meeting; and
determining a likelihood score for the second room based on the calendar entry.

13. A non-transitory computer-readable storage medium storing instructions executable by a processor, the instructions when executed by the processor causing the processor to perform steps including:
detecting one or more individuals having access to a directory of entities that can be contacted from a room management client;
determining likelihood scores for each of the entities in the directory, the likelihood scores indicative of respective predicted likelihoods that the one or more individuals having access to the directory of entities on the room management client will want to contact each of the respective entities in the directory;
organizing a presentation of the entities in the directory based on the likelihood scores to generate a ranked list of entities; and
causing the ranked list of entities to be displayed on the room management client.

14. The non-transitory computer-readable storage medium of claim 13, wherein detecting the one or more individuals comprises:
detecting a proximity of the one or more individuals to the room management client.

15. The non-transitory computer-readable storage medium of claim 13, wherein determining the likelihood scores comprises:
identifying expected participants in a scheduled meeting stored to a calendar application corresponding to a location of the room management client;
detecting a presence or absence of the expected participants at the location; and
determining the likelihood scores based on the presence or absence of the expected participants.

16. The non-transitory computer-readable storage medium of claim 13, wherein determining the likelihood scores comprises:
determining an room location associated with the room management client;
determining entity locations associated with each of the entities in the directory;
determining respective distances from the room location to each of the entity locations; and
determining the likelihood scores based on the respective distances.

17. The non-transitory computer-readable storage medium of claim 16, wherein determining the entity locations comprises:
determining, based on a stored calendar event associated with a given entity, an expected location of the given entity indicated by the stored calendar event; and
determining the entity locations based on the expected location.

18. The non-transitory computer-readable storage medium of claim 16, wherein determining the entity locations comprises:
determining an estimated location of a given entity based on a detection of the given entity by a proximity detector located at the estimated location; and
determining the entity locations based on the estimated location.

19. A computing device comprising:
one or more processors; and
a non-transitory computer-readable storage medium storing instructions executable by the one or more processors, the instructions when executed by the processor causing the one or more processors to perform steps including:
detecting one or more individuals having access to a directory of entities that can be contacted from a room management client;
determining likelihood scores for each of the entities in the directory, the likelihood scores indicative of respective predicted likelihoods that the one or more individuals having access to the directory of entities on the room management client will want to contact each of the respective entities in the directory;
organizing a presentation of the entities in the directory based on the likelihood scores to generate a ranked list of entities; and
causing the ranked list of entities to be displayed on the room management client.

20. The computing device of claim 1, wherein detecting the one or more individuals comprises:
detecting a proximity of the one or more individuals to the room management client.
